(19) United States
(12) Patent Application Publication
(10) Pub. No.: US 2003/0164297 A1
(43) Pub. Date: Sep. 4, 2003

(54) Electrophoretic inorganic porous material

(75) Inventors: Joseph P. Day, Pacifica, CA (US); Joydeep Lahiri, Painted Post, NY (US); Santona Pal, Painted Post, NY (US); Mark A. Quesada, Horseheads, NY (US); Youchun Shi, Horseheads, NY (US)

Correspondence Address: CORNING INCORPORATED, SP-TI-3-1, CORNING, NY, 14831

(73) Assignee: Corning Incorporated

(21) Appl. No.: 10/090,196

(22) Filed: Mar. 4, 2002

(51) Int. Cl. G01N 27/26; G01N 27/447

(52) U.S. Cl. 204/469; 204/466; 204/456; 204/450; 204/600; 204/606; 204/616

(57) ABSTRACT

An electrophoretic inorganic porous material, electrophoresis apparatus and method for analyzing a biological sample using the electrophoretic inorganic porous material are described. The electrophoretic inorganic porous material is an inorganic separating media that has a plurality of pores in which molecules from the biological sample (e.g., amino acids, proteins, nucleic acids, DNA) migrate during an electrophoresis process. There are disclosed two embodiments of the electrophoretic inorganic porous material including a porous glass and a sol gel monolith.

### BACKGROUND OF THE INVENTION

1. Field of the Invention

The present invention relates in general to the biotechnology field and, in particular, to an electrophoretic inorganic porous material and a method for analyzing a biological sample using the electrophoretic inorganic porous material as separating media.

2. Description of Related Art

Electrophoresis is a well known separation process in which molecules (e.g., amino acids, proteins, nucleic acids, DNA) migrate through a separation media under the influence of an electric field. Electrophoresis is an important tool in molecular biology and is of critical value in many aspects of genetic manipulation and study. One use of electrophoresis is in the identification of particular DNA molecules by the band patterns they yield in the separation media after being cut with various restriction enzymes. Viral DNA, plasmid DNA, and particular segments of chromosomal DNA can all be identified in this way. Another use of electrophoresis is in the isolation and purification of individual fragments that contain interesting genes, which can be recovered from the separation media with full biological activity. Moreover, electrophoresis has made it possible to sequence the entire genomes of many organisms to determine the genetic difference and the evolutionary relationship among different species of plants and animals. These are just some of the many uses of electrophoresis.

The traditional separation media used in the electrophoresis process is an organic polymer matrix such as an agarose gel or a polyacrylamide gel. An agarose gel is cast by melting agarose into an aqueous solution and allowing the melted agarose to slowly cool to room temperature. The molten agarose swells in water and takes the shape of a cast. Agarose is a linear polysaccharide (average molecular mass about 12,000 Dalton) made up of the basic repeat unit agarobiose, which comprises alternating units of galactose and 3,6-anhydrogalactose. Agarose gel has relatively large “pore” sizes which are used primarily to separate very large molecules with a molecular mass greater than 200 kDal. The percentage of agarose in the gel matrix is used to control the porosity of the matrix and subsequently the resolution of the bands. The agarose gels do not allow for fine separations and are largely used for nucleic and separations only. Moreover, the agarose gel is very fragile and is easily destroyed by handling.

Polyacrylamide gel may be prepared so as to provide a wide variety of electrophoretic conditions. For example, the pore size in the polyacrylamide gel may be varied to produce different molecular sieving effects for separating proteins of different sizes. In particular, relatively precise pore sizes can be obtained in polyacrylamide gels by controlling the percentage of polyacrylamide in a given gel. Polyacrylamide gel can be cast in a single percentage or with varying gradients of polyacrylamide. Gradient polyacrylamide gels provide pores that continuously decrease in size from the top to the bottom of the gel, resulting in thin bands. Because of this banding effect, detailed genetic and molecular analysis can be performed on gradient polyacrylamide gels. Even though the polyacrylamide gel is associated with the toxic acrylamide, polyacrylamide gels offer greater flexibility and more sharply defined banding than agarose gels.

While the performance of the traditional organic separating media (e.g., polyacrylamide gels, agarose gels) satisfies the needs of many analytical separations, critical applications such as the analysis of protein expression in a pharmaceutically important cell line demands rigorous levels of reproducibility which are simply lacking with traditional organic separating media. In particular, the traditional organic separating media has pore sizes that are difficult to reproduce because of the many different manufacturing conditions that must be consistent when making different batches of the traditional organic separating media. Some of the different manufacturing conditions that effect the pore sizes in the traditional organic separating media include, for example, the extent of degassing, the oxygen level and temperature control of the polymerizing mixture, the initial distribution of the catalyst and initiator in the polymerizing mixture, the extent of pre-electrophoresis. As a result, it is very difficult to reproduce the traditional organic separating media that has the desired pore sizes. In fact, significant efforts are needed to ensure the validity of gel-to-gel comparisons in all proteomic applications. Accordingly, there is a need for a new separating media that is designed to address the aforementioned reproducibility problems and other problems associated with the traditional organic separating media. This need and other needs are addressed by the electrophoretic inorganic porous material and method of the present invention.

### BRIEF DESCRIPTION OF THE INVENTION

The present invention includes an electrophoretic inorganic porous material, electrophoresis apparatus and method for analyzing a biological samples using the electrophoretic inorganic porous material. The electrophoretic inorganic porous material is an inorganic separating media that has a plurality of pores in which molecules from the biological sample (e.g., amino acids, proteins, nucleic acids, DNA) migrate during an electrophoresis process. There are disclosed two embodiments of the electrophoretic inorganic porous material including a porous glass and a sol gel monolith.

### BRIEF DESCRIPTION OF THE DRAWINGS

A more complete understanding of the present invention may be had by reference to the following detailed description when taken in conjunction with the accompanying drawings wherein:

FIGS. 1A-1B respectively illustrate a perspective view and a sectional side view of an electrophoresis apparatus incorporating an inorganic porous material in accordance with the present invention;

FIG. 2 is a flowchart illustrating the steps of a preferred method for analyzing a biological sample in accordance with the present invention;

FIG. 3 illustrates an image of electrophoretic separations of molecules within a first embodiment of the inorganic porous material shown in FIGS. 1A and 1B; and

FIG. 4 illustrates an image of electrophoretic separations of molecules within a second embodiment of the inorganic porous material shown in FIGS. 1A and 1B.

### DETAILED DESCRIPTION OF THE DRAWINGS

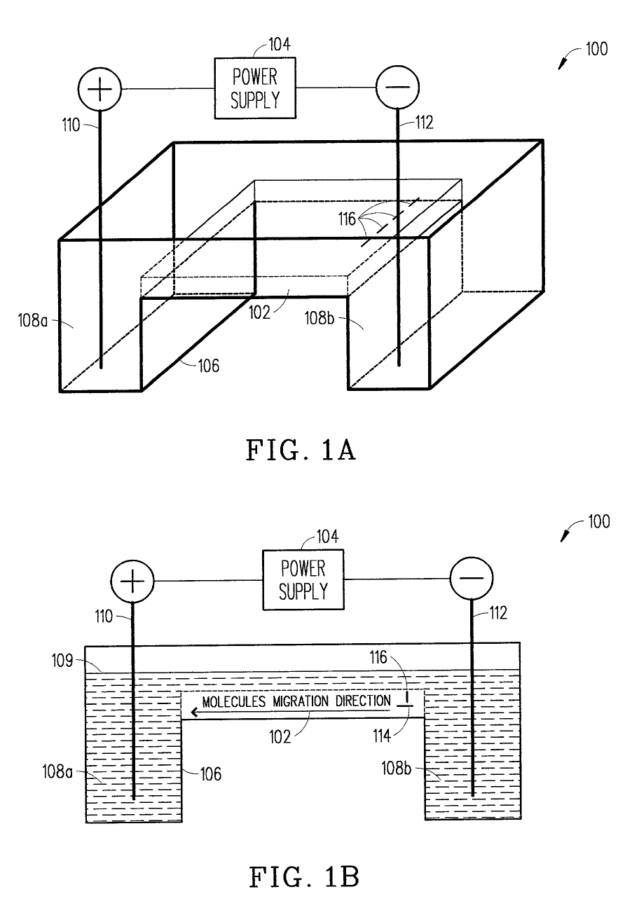

Referring to FIGS. 1-4, there are disclosed two embodiments of an electrophoretic inorganic porous material 102 and a preferred method 200 for analyzing a biological sample using the inorganic porous material 102 as a separating media in an electrophoresis process. Although the electrophoretic inorganic porous material 102 of the present invention is described as being used in electrophoresis apparatus 100, it should be understood that the electrophoretic inorganic porous material 102 can be used in many different types of electrophoresis apparatuses. Accordingly, the inorganic porous materials 102, the electrophoresis apparatus 100 and the preferred method 200 should not be construed in a limited manner.

Referring to FIGS. 1A-1B, there are respectively illustrated a perspective view and a sectional side view of the electrophoresis apparatus 100 incorporating the inorganic porous material 102. The electrophoresis apparatus 100 includes a power supply 104 and a buffer tank 106 (shown made from a transparent material) configured to support the inorganic porous material 102. The buffer tank 106 has two reservoirs 108a and 108b each of which is configured to contain a buffer 109 (e.g., potassium phosphate solution) (shown in FIG. 1B). The inorganic porous material 102 is immersed in the buffer 109.

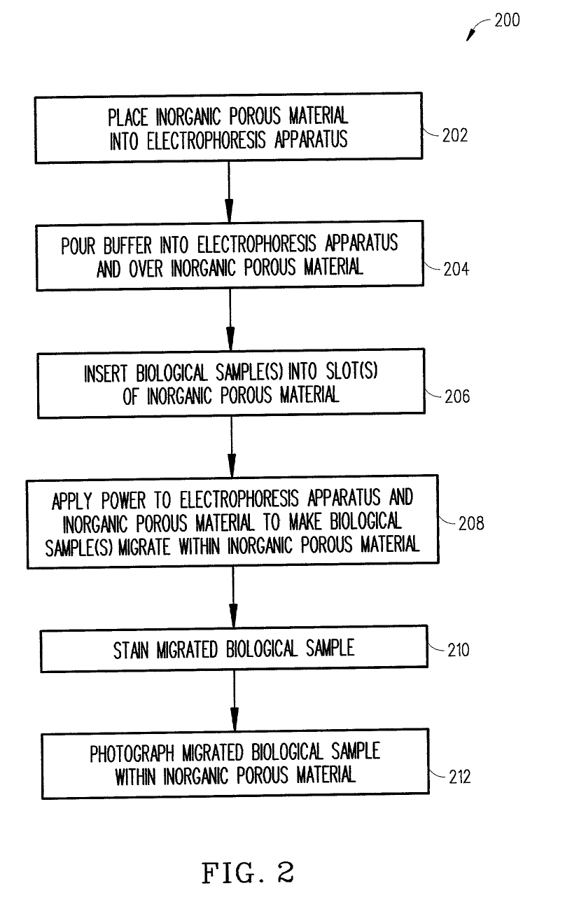

The power supply 104 has a positive electrode 110 and a negative electrode 112. The positive electrode 110 is located in reservoir 108a and immersed in the buffer 109. The negative electrode 112 is located in reservoir 108b and also immersed in the buffer. As shown, the positive electrode 110 and the negative electrode 112 are located at opposite ends of the inorganic porous material 102. The inorganic porous material 102 is an inorganic separating media that has a series of pores through which molecules of a biological sample 114 (shown in FIG. 1B) are able to migrate when power is applied to the positive and negative electrodes 110 and 112. The biological sample can include, for example, amino acids, proteins, nucleic acids and DNA. A detailed discussion as to how a researcher can use the electrophoresis apparatus 100 to analyze the biological sample 114 and a detailed discussion about the different embodiments of the inorganic porous material 102 are provided below with respect to FIGS. 2-4.

It should be understand that the electric polarity setup shown is for DNA separation. DNA molecules have a negative charge, and they move from the negative electrode 112 towards the positive electrode 110 under an electric field. While protein separation is more complicated, a protein can be negatively charged or positively charged depending on the pH value of buffer solution 109. If proteins to be separated are negatively charged in the buffer solution selected, then the polarity setup as shown can be used. If proteins to be separated are positively charged in the selected buffer solution 109, then an opposite electric polarity setup as shown is needed. In this case, the proteins move from the positive electrode 110 towards the negative electrode 112.

Referring to FIG. 2, there is a flowchart illustrating the steps of the preferred method 200 for analyzing one or more biological samples using the inorganic porous material 102 as a separating media in an electrophoresis process. Beginning at step 202, the researcher places the inorganic porous material 102 into the electrophoresis apparatus 100. Again, the inorganic porous material 102 is a separating media that has a plurality of pores in which molecules from the biological sample 114 are able to migrate during the electrophoresis process. The inorganic porous material 102 can be a porous glass 102a (first embodiment) or a sol gel monolith 102b (second embodiment). Details about the porous glass 102a and the sol gel monolith 102b are provided below.

At step 204, the researcher pours the buffer 109 into the electrophoresis apparatus 100 so as to immerse the inorganic porous material 102. In particular, the buffer 109 is poured into the reservoirs 108a and 108b and also over the top of the inorganic porous material 102 located between the reservoirs 108a and 108b. The buffer 109 (e.g., potassium phosphate solution) helps maintain an optimum pH for the electrophoresis process. Alternatively, it should be noted that the inorganic porous material 102 can be placed into the electrophoresis apparatus 100 which already contains the buffer 109.

At step 206, the researcher can use a micropipettor (for example) to insert one or more biological samples 114 into one or more slots 116 (four slots shown in FIG. 1A) of the inorganic porous material 102. Typically, the researcher adds either sucrose or glycerol to the biological sample(s) 114 to make them dense and “sink” into the slots 116. Moreover, the researcher can add one or more tracking dyes (e.g., blue tracking dyes) to the biological sample(s) 114 to track the extent of electrophoresis by a visible indicator.

At step 208, the researcher turns on the power supply 104 and creates an electric field within the inorganic porous material 102 such that the molecules of the biological sample(s) 114 migrate through the pores formed within the inorganic porous material 102. The molecules are able to migrate, because the negative electrode 112 repels negatively charged molecules while the positive electrode 110 simultaneously attracts the negatively charged molecules. Thus, the molecules are forced to move through the pores when the electrical current is applied to the inorganic porous material 102. The frictional force within the pores of the inorganic porous material 102 acts as a “molecular sieve,” separating the molecules by size. The rate of the molecule's migration within the pores depends on a number of factors including, for example, the strength of the electrical field, the size and shape of the molecules, the relative hydrophobicity of the biological samples, and the ionic strength and temperature of the buffer in which the molecules are moving.

At step 210, the researcher can stain the migrated molecules of the biological sample(s) 114. For example, ethidium bromide binds to the nucleic acid molecules (such as double stranded DNA) and makes them fluorescent orange under ultraviolet light. After step 210, the separated molecules in each lane of the inorganic porous material 102 can be easily seen in a series of bands spread from one end to the other end of the inorganic porous material 102.

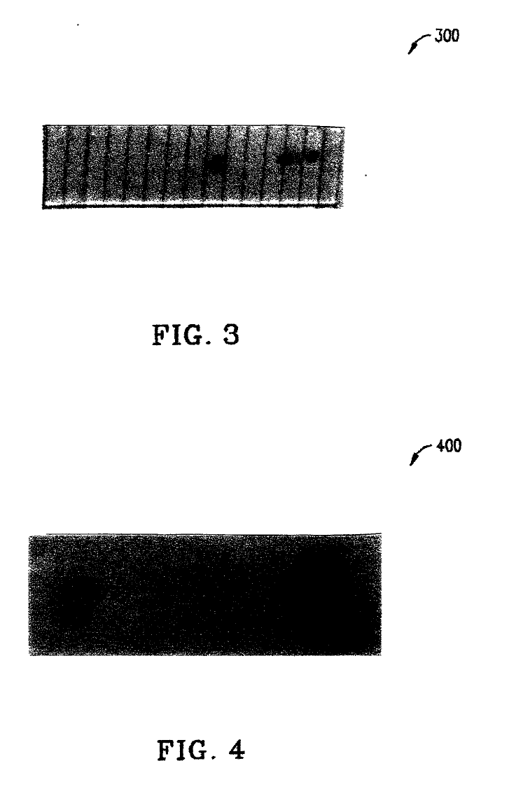

At step 212, the researcher can then photograph the inorganic porous material 102 so as to have a record of the relative locations of the migrated molecules of the biological sample(s) 114. The inventors have conducted several experiments, the results of which are shown in FIGS. 3 and 4 which illustrate images of actual electrophoretic separations of molecules in porous glass 102a and sol gel monolith 102b. The images in FIGS. 3 and 4 indicate that actual separations of molecules in the porous glass 102a and the sol gel monolith 102b are similar to the separations of molecules using the traditional organic separating media (e.g., agarose gel, polyacrylamide gel).

It should be understood that the surface of the inorganic porous material 102a and 102b is negatively charged under most pH buffer conditions. There are two problems associated with having a negatively charged surface. First, proteins with positive charges are adsorbed on surface, which reduces separation resolution. Secondly, it is difficult to control the electro osmotic flow which is very sensitive to the buffer condition and surface condition on pores in the inorganic porous material 102a and 102b. This poor control in turn causes poor reproducibility of separation. For these two reasons, it is important to suppress the surface charge on the inorganic porous material 102a and 102b. To accomplish this, a non-charged coating material (e.g., polyethylene glycol (PEG)) can be used on the silica surface.

FIG. 3 shows an image that was created by loading standard electrophoresis tracking dyes (e.g., Fisher, BP633-5) that allows one to monitor the separation of a 4000 base-pair DNA sample, a 600 base-pair DNA sample and a 150 base-pair DNA sample onto a VYCOR® porous glass microscope slide 300 (Corning Inc., Lot#9990111). The VYCOR® porous glass microscope slide 300 was mounted in a submarine gel electrophoresis apparatus containing a 1/2xTBE (Tris-Borate-EDTA) running buffer. The image in FIG. 3 illustrates the electrophoretic separations of the DNA samples that was obtained when the spotted VYCOR® porous glass microscope slide 300 was run in an electric field of 7.50 Volts/cm for approximately two hours. It should be noted that the migrated 4000 base-pair DNA tracking dye (right spot) was very close to where the tracking mixture was initially introduced to the VYCOR® porous glass microscope slide 300. The electrophoresis results in the separation of the 150, 600 and 4000 base-pair DNA molecules. The 150 base-pair DNA fragment migrates the fastest and is visualized as the leftmost spot in FIG. 3. It should also be noted that the vertical lines in the image are there because the VYCOR® porous glass microscope slide 300 was photographed on a sheet of lined paper.

FIG. 4 shows an image illustrating an example of electrophoretic separations of molecules in the sol gel monolith 102b. In this example, a mixture of tracking dyes and a single stained DNA oligomer (50mer) was separated on a sol gel monolith substrate 400 having the dimensions of 4.5 cm×1.5 cm×0.4 cm. In particular, the sol gel monolith substrate 400 which had an average pore size of 160 Å was mounted in a submarine gel electrophoresis apparatus containing a 1/2xTBE (Tris-Borate-EDTA) running buffer. The image in FIG. 4 illustrates the electrophoretic separations of the DNA sample that was obtained when the sol gel monolith substrate 400 was run in the presence of an electric field of 12.40 Volts/cm for approximately thirty minutes. The surface of the sol gel monolith substrate 400 was treated with 3% N-(3-triethoxysilylpropyl) gluconamide in ethanol for around 12 hours. Details about the porous glass 102a and the sol gel monolith 102b are provided below.

The porous glass 102a can made from alkali borosilicate glass. A commonly known and commercially available alkali borosilicate glass is sold under the name VYCOR®, product code 7930, which is available from the assignee of the present invention. Basically, VYCOR® glass is an open-cell, porous glass which exhibits excellent filtration properties including, for example, rigidity, chemical inertness and controlled microporosity. The composition and the physical properties of VYCOR® glass are provided below.

| COMPOSITION OF VYCOR ® GLASS | |
|---|---|
| SiO₂ | 96% |
| B₂O₃ | 3% |
| Na₂O | 0.40/a |
| R₂O₃ ± RO₂ | <1% |

Where R = Mostly Al₂O₃ and ZrO₂.
PHYSICAL PROPERTIES OF VYCOR ® GLASS

| Approx. Specific Gravity (dry) | 1.5 | |
|---|---|---|
| Void Space | 28% | of Vol. |
| Internal Surface Area | 250 | M²1 gram |
| Avg. Pore Diameter (Standard) | 40 | Å |
| Appearance | opalescent | |
| Avg. Modulus of Rupture of Abraded | 6000 | psi |
| “A” rods, 25° C. | | |
| Young's Elastic Modulus, 25° C. | 2.5 × 10⁶ | psi |
| Loss Tangent at 25° C., 100 Hz | .007* | |
| Dielectric Constant at 25° C., 100 Hz | 3.1* | |

*Loss Tangent and Dielectric Constant are affected by water in porous glass. The above porous glass sample was activated at 400° C., cooled in a desiccator, and immediately measured to minimize water pickup.

As indicated above, the average pore size is generally 40 Å in the commercially available VYCOR® glass. It may be necessary to enlarge the pores of the glass so that the average pore size is greater than or equal to 100 Å to better enable the migration of certain types of molecules. To enlarge the pore size, one could (1) heat treat the VYCOR® glass to create a leached porous glass, and (2) chemically etch (possibly sequentially etch) the leached porous glass to remove silicate debris left behind from the heating step and to further etch the silicate structure of the leached porous glass. Each enlargement process increase the average pore size by approximately 4 nm. Thus, it may take multiple enlargement processes to enlarge the pore sizes to 100 Å or greater.

It should be noted that VYCOR® glass is readily available in sheets that can be cut into appropriately sized glass sheets that can fit into a particular electrophoresis apparatus. For example, the VYCOR® glass sheets can be cut to have the same size of the traditional organic separating media (e.g., 4.5 cm×1.5 cm×0.4 cm). Moreover, VYCOR® glass can be fabricated in any desired shape and size which means that VYCOR® glass has many of the same advantageous properties associated with acrlamide-bonded glass without the requirement of doing any silane coupling and acrylamide polymerization on the silanized surface of the acrlamide-bonded glass.

It should also be noted that a variety of porous glasses now known or subsequently developed that have similar properties to VYCOR® glass can be used in the present invention. For a description of different types of porous glasses and different methods of producing porous glasses reference is made to an article entitled “Porous and Reconstructed Glasses,” Engineered Material Handbook (1992), Volume 4, Ceramic and Glasses, pp. 427-432, the contents of which are incorporated herein by reference.

The sol gel monolith 102b is an optically transparent amorphous silica or silicate material produced by forming interconnections in a network of colloidal, submicrometer particles until the network becomes sufficiently rigid. The sol gel monolith 102b is about one-half the density of glass.

A sol gel monolith 102b that has a relatively large pore size (e.g., >100 Å) can be made using an acid catalyzed fast hydrolysis manufacturing process. One such manufacturing process includes the following steps:

Making silica sol by enabling the hydrolysis of tetramethyl orthosilicate with HF/HNO₃ in an ice water bath. For alternatives, see TABLE 1 which lists the starting materials and pores sizes of different sol gel monoliths 102b.

TABLE 1

| Pore Radius | | | | | |
|---|---|---|---|---|---|
| Å | H₂O | CH₃OH | TMOS | HF (3%) | HNO₃(IN) |
| (Nominal) | (ml) | (ml) | (ml) | (ml) | (ml) |
| 30 | 50 | 0 | 35 | 1.5 | 10 |
| 45 | 50 | 0 | 35 | 2.5 | 10 |
| 100* | 25 | 50 | 35 | 4 | 4 |
| 150* | 25 | 50 | 35 | 12.5 | 4 |
| 200* | 50 | 50 | 35 | 10 | 4 |
| 250* | 50 | 50 | 35 | 12.5 | 4 |
| 400* | 50 | 50 | 35 | (2.25 ml of | 0 |
| | | | | 25% H₂SiF₆) | |

*Indicates reactants cooled in an ice bath (approx. 5° C.) prior to mixing. TMOS = tetrmethoxy silane.

Casting of the silica sol in a hydrophobic (e.g., polystyrene, polypropylene, polycarbonate) container to form a gel. The transformation to a gel can occur within a few minutes. The gel can be cast to fit into any type of electrophoresis apparatus.

Aging of the gel at 50° C. for 7-14 days.

Drying the gel at 150° C. for a few hours to form the sol gel monolith 102b.

Burning off unreacted methoxyl group at a relatively high temperature (e.g., approximately 600° C.). Depending on the application, this step may not be necessary.

For a more detailed description about the sol gel monolith 102b and how to manufacture the sol gel monolith 102b reference is made to an article entitled “Sol-Gel Synthesis and Processing,” Ceramic Transactions (1998), Volume 95, pp. 173-182, the contents of which are incorporated herein by reference.

It should be noted that a variety of silicate materials now known or subsequently developed that have similar properties to the above-described sol gel monolith 102b can be used in the present invention. Moreover, it should be noted that the inventors believe that the sol gel monolith 102b may be more suitable for high resolution electrophoresis than porous glass 102a (e.g., VYCOR® glass) because:

The sol gel monolith 102b has more uniform and narrow pore size distributions when compared to VYCOR® glass 102a.

The sol gel monolith 102b has a higher porosity when compared to VYCOR® glass 102a.

It is easier to produce a sol gel monolith 102b that has larger pore sizes (e.g., >200 Å) than it is to produce VYCOR® glass 102a that has large pore sizes.

Following are some other advantages, features and capabilities of the present invention:

The inorganic porous material 102 can be manufactured to be a relatively thin structure which can enhance the high speed electrophoresis performance when compared to traditional organic separating media.

The inorganic porous material 102 can be modified by attachment chemistries (e.g., ethylene glycol to inhibit absorption, ampholyte immobilization for isoelectric focusing, “neutral” glass surfaces to prevent electro osmosis) such that the inorganic porous material 102 can be used in demanding electrophoretic applications.

The inorganic porous material 102 can be used in a wide variety of applications including (for example):

Separation of proteins in western blots.

Separation of proteins in 2-dimensional electrophoresis.

Separation of DNA in dot blots.

Miniaturized DNA sequencing.

Electrophoresis under native and denaturing conditions.

Using the inorganic porous medium for chip based electrophoretic separation as part of a microscale total analysis system (pTAS).

Using the inorganic porous medium to combine mass spectroscopy in tandem with electrophoresis.

Etc . . .

Although only two embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. An electrophoretic inorganic porous material, comprising:
an inorganic separating media that has a plurality of pores through which molecules migrate during an electrophoresis process.

2. The electrophoretic inorganic porous material of claim 1, wherein said inorganic separating media is porous glass.

3. The electrophoretic inorganic porous material of claim 2, wherein said porous glass is alkali borosilicate glass.

4. The electrophoretic inorganic porous material of claim 2, wherein said porous glass has pores with an average pore diameter greater than 100 angstroms.

5. The electrophoretic inorganic porous material of claim 1, wherein said inorganic separating media is a sol gel monolith.

6. The electrophoretic inorganic porous material of claim 5, wherein said sol gel monolith has pores with an average pore diameter greater than 100 angstroms.

7. The electrophoretic inorganic porous material of claim 1, wherein said molecules are proteins.

8. The electrophoretic inorganic porous material of claim 1, wherein said molecules are nucleic acids.

9. An electrophoresis apparatus, comprising:
a power supply including a positive electrode and a negative electrode; and
a buffer tank capable of supporting an inorganic separating media that has a plurality of pores, said buffer tank further capable of containing a buffer that covers the inorganic separating media such that molecules migrate within the plurality of pores when power is applied to the positive electrode and the negative electrode both of which are immersed in the buffer and located at opposite ends of the inorganic separating media.

10. The electrophoresis apparatus of claim 9, wherein said inorganic separating media is porous glass.

11. The electrophoresis apparatus of claim 10, wherein said porous glass is alkali borosilicate glass.

12. The electrophoresis apparatus of claim 10, wherein said porous glass has pores with an average pore diameter greater than 100 angstroms.

13. The electrophoresis apparatus of claim 9, wherein said inorganic separating media is a sol gel monolith.

14. The electrophoresis apparatus of claim 13, wherein said sol gel monolith has pores with an average pore diameter greater than 100 angstroms.

15. The electrophoresis apparatus of claim 9, wherein said molecules are proteins.

16. The electrophoresis apparatus of claim 9, wherein said molecules are nucleic acids.

17. A method for analyzing a biological sample, said method comprising the steps of:
placing an inorganic separating media into an electrophoresis apparatus;
pouring a buffer into the electrophoresis apparatus to immerse the inorganic separating media;
inserting the biological sample into the inorganic separating media; and
applying power to the inorganic separating media such that molecules of the biological sample migrate within a plurality of pores formed within the inorganic separating media.

18. The method of claim 17, further comprising the steps of:
staining the biological sample; and
photographing the inorganic separating media to have a record of the migrated molecules of the biological sample.

19. The method of claim 17, wherein said inorganic separating media is porous glass.

20. The method of claim 19, wherein said porous glass is alkali borosilicate glass.

21. The method of claim 19, wherein said porous glass has pores with an average pore diameter greater than 100 angstroms.

22. The method of claim 17, wherein said inorganic separating media is a sol gel monolith.

23. The method of claim 22, wherein said sol gel monolith has pores with an average pore diameter greater than 100 angstroms.

24. The method of claim 17, wherein said molecules are proteins.

25. The method of claim 17, wherein said molecules are nucleic acids.

26. The method of claim 17, wherein said inorganic separating media enables a combination of mass spectroscopy and electrophoresis.

27. The method of claim 17, wherein said inorganic separating media enables separation of proteins in western blots.

28. The method of claim 17, wherein said inorganic separating media enables separation of proteins in 2-dimensional electrophoresis.

29. The method of claim 17, wherein said inorganic separating media enables separation of DNA in dot blots.

30. The method of claim 17, wherein said inorganic separating media enables miniaturized DNA sequencing.

31. The method of claim 17, wherein said inorganic separating media enables electrophoresis under native and denaturing conditions.

32. The method of claim 17, wherein said inorganic separating media is a component in a microscale total analysis system.
